(19) United States
(12) Patent Application Publication
(10) Pub. No.: US 2010/0248082 A1
(43) Pub. Date: Sep. 30, 2010

(54) FUEL CELL SYSTEM

(75) Inventor: Takeshi MINAMIURA, Kobe-shi (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 12/732,906

(22) Filed: Mar. 26, 2010

(30) Foreign Application Priority Data
Mar. 27, 2009 (JP) 2009-079978
Feb. 18, 2010 (JP) 2010-033215

(51) Int. Cl. H01M 8/02

(52) U.S. Cl. 429/513

(57) ABSTRACT

A fuel cell system includes: a fuel cell; a fuel tank provided opposite to the fuel cell and adapted to contain hydrogen absorbing alloy; and a supply channel adapted to supply hydrogen discharged from the hydrogen absorbing alloy to the fuel cell. The fuel cartridge is provided with a discharging unit adapted to discharge hydrogen from the hydrogen absorbing alloy to the supply channel. The discharging unit is provided opposite to the center of the fuel cell.

### CROSS-REFERENCE TO RELATED APPLICATIONS

This application is based upon and claims the benefit of priority from the prior Japanese Patent Application No. 2009-079978, filed on Mar. 27, 2009 and Japanese Patent Application No. 2010-033215, filed on Feb. 18, 2010, the entire contents of which are incorporated herein by reference.

### BACKGROUND OF THE INVENTION

1. Field of the Invention

The present invention relates to a fuel cell system adapted to generate electricity using a fuel gas containing hydrogen.

2. Description of the Related Art

Recently, fuel cells are attracting public attention due to its high energy conversion efficiency and absence of toxic materials produced as a result of generating electricity. Fuel cells produce heat when generating electricity. Fuel cells are provided with an electrolyte membrane. For stable generation of electricity, it is important to maintain the humid condition of the electrolyte membrane and to maintain the temperature of the fuel cell as a whole at an appropriate level.

Fuel cells provided with an integral tank for containing a fuel in addition to the cell main unit are devised for use in mobile devices. One known example of such a fuel cell comprises a fuel cartridge configured to discharge a fuel in an endothermic reaction, an electricity generator configured to generate electricity using the fuel introduced from the fuel cartridge and producing heat as a result, and an external heat dissipater configured to discharge heat generated in the electricity generator. The fuel cell as disclosed is provided with a heat transfer means configured to connect the electricity generator, the fuel cartridge, and the external heat dissipater, supply the heat generated in the electricity generator to the fuel cartridge and the external heat dissipater, control the supply of heat in accordance with the temperature of the electricity generator and the fuel cartridge, and maintain the temperature of the electricity generator and the fuel cartridge within a certain range.

There is also known a fuel cell stack designed to heat the peripheral part of the end cells more efficiently than the central part so as to average the temperature distribution, and to prevent temperature difference from occurring at the end cells.

The temperature distribution in a fuel cell generating electricity differs depending on the shape of the fuel cell and the number of fuel cells provided inside, and the distribution is not even. For this reason, it is difficult to eliminate difference in local temperature in a fuel cell, and, in particular, to prevent uneven temperature distribution among the cells, merely by supplying the heat generated in the electricity generator to the fuel cartridge and the external heat dissipater and controlling the supply of heat depending on the temperature of the electricity generator and the fuel cartridge.

### SUMMARY OF THE INVENTION

The present invention addresses the challenge and a purpose thereof is to provide a technology to mitigate unevenness temperature distribution due to heat generation at the time of generating electricity, using a simple configuration.

A fuel cell system according to one embodiment of the present invention that addresses the challenge comprises: a fuel cell including an electrolyte membrane, a cathode provided on one surface of the electrolyte membrane, and an anode provided on the other surface of the electrolyte membrane; a fuel cartridge provided opposite to the fuel cell and adapted to contain hydrogen absorbing alloy; and a supply channel adapted to supply hydrogen discharged from the hydrogen absorbing alloy to the fuel cell. The fuel cartridge is provided with a discharging unit adapted to discharge hydrogen from the hydrogen absorbing alloy to the supply channel. The discharging unit is provided opposite to the center of the fuel cell.

Since a fuel cell generates heat when it generates electricity and heat dissipation is poor at the center than at the periphery thereof, the temperature at the center is particularly likely to rise. Hydrogen absorbing alloy undergoes an endothermic reaction in the process of discharging hydrogen absorbed. Thus, according to this embodiment, the discharging unit that discharges hydrogen is provided opposite to the center of the fuel cell, heat generated while electricity is being generated is canceled by the endothermic reaction in the neighborhood of the discharging unit. As a result, temperature increase at the center of the fuel cell is mitigated and unevenness of the temperature distribution is moderated.

The fuel cartridge may include a plurality of fuel tanks configured to contain hydrogen absorbing alloy and provided with a discharging unit.

Each of the plurality of fuel tanks may be arranged so that the discharging unit is located at the center of the fuel cartridge.

The fuel cartridge may be configured such that a plurality of fuel tanks containing hydrogen absorbing alloy are arrange on a plane, and the fuel tanks may be arranged such that one of the ends thereof provided with the discharging unit is located near the center of the fuel cartridge.

This reduces the volume of hydrogen absorbing alloy per fuel tank as compared to the fuel cartridge in which all hydrogen absorbing alloy pieces are contained in a single housing. This increases the rigidity of the housing used in the fuel tank and the flexibility in the shape of the housing, allowing cost reduction and miniaturization. By using general-purpose fuel tanks, the fuel cartridge adapted for the performance of the fuel cell and the type of the cell phone connected to the cell can be easily manufactured simply by changing the number of fuel tanks. Additionally, since each of the plurality of fuel tanks is arranged so that the discharging unit thereof is located at the center of the fuel cartridge, the center of the fuel cell in which the temperature is likely to rise can be efficiently cooled. By arranging the fuel tanks on a plane, the thickness of the fuel cartridge can be reduced. In the case that the fuel cartridge has a rectangular shape as a whole, the term “center” may not only be understood to mean an area including the center from all sides but also an area including the center of the two opposite sides.

The fuel tank may be provided with a supply unit configured to supply hydrogen to the end opposite to the end provided with the discharging unit. Hydrogen absorbing alloy generates heat when the alloy is filled with hydrogen. When the temperature of the hydrogen absorbing alloy is high, it takes time to charge the alloy with hydrogen. Since the periphery of the fuel tank dissipates heat to the atmosphere more efficiently than the center, heat dissipation is facilitated and time required for filling the alloy with hydrogen is reduced by providing a filler unit at the end opposite to the end provided with the discharging unit. By providing a filler unit at the end opposite to the end provided with the discharging unit, the periphery, which is at a lower temperature than the center of the fuel cell, can be heated. Therefore, unevenness of the temperature distribution in the fuel cell is further mitigated as compared with the case of only cooling the center of the fuel cell.

The system may further be provided with a filler unit that fills a space between the fuel cell and the fuel tanks. The filling unit may be formed to conform to the shape of the fuel tanks. This makes heat transfer between the fuel cell and the fuel tanks due to the temperature difference easier than in the case where a large space exists between the fuel cell and the fuel tanks, thereby promoting uniform temperature distribution in the fuel cell.

The fuel tank may be provided with a housing, a molded hydrogen absorbing alloy contained in the housing, and a filler member filling a gap between the interior surface of the housing and the hydrogen absorbing alloy. The filler member may comprise an elastic material deformed in accordance with contraction and expansion of the hydrogen absorbing alloy. By blocking a channel through which hydrogen is discharged from the hydrogen absorbing alloy, and by providing pressure gradation in the hydrogen absorbing alloy, it is ensured that hydrogen pressure in the neighborhood of the discharging unit is lower than in the other areas, facilitating discharge of hydrogen from the neighborhood of the discharging unit. For example, by designing the shape of the filler member so as to facilitate discharge of hydrogen from the neighborhood of the discharging unit, the temperature of the area in the neighborhood of the discharging unit is lowered and the temperature gradation is provided accordingly.

The filler member may be provided with a heat conducting unit adapted to conduct heat generated in the fuel cell to the hydrogen absorbing alloy. This facilitates conduction of heat generated in the fuel cell to the hydrogen absorbing alloy and discharge of hydrogen from the hydrogen absorbing alloy.

The filler member may be provided with a heat insulating unit that blocks the flow of heat from the area away from the discharging unit toward the discharging unit via the heat conducting unit. This allows the temperature difference between the area away from the discharging unit and the neighborhood of the discharging unit to be maintained easily and lowers the temperature in the neighborhood of the discharging unit.

The heat conducting unit may be provided with a first heat conducting unit provided in the neighborhood of the discharging unit and a second heat conducting unit provided in the neighborhood of the area opposite to the discharging unit. The heat insulating unit may be provided at a location sandwiched by the first heat conducting unit and the second heat conducting unit.

The system may further be provided with a heat conducting member sandwiched by the fuel cell and the fuel cartridge and promoting heat conduction between the fuel cell and the fuel cartridge. This facilitates transfer of heat due to the temperature difference between the fuel cell and the fuel cartridge and promotes uniform temperature distribution in the fuel cell.

The heat conducting member may be configured such that the heat conductivity at the center within the plane is larger than the heat conductivity at the edges. This facilitates transfer of heat at the center of the fuel cell toward the edges or toward the fuel cartridge via the center of the heat conducting member, thereby promoting uniform temperature distribution in the fuel cell.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1A is a schematic view of a fuel cell main unit and a fuel cartridge of a fuel cell system, and FIG. 1B is a top view showing temperature distribution in a fuel cell occurring when electricity is generated;

FIG. 2 is an exploded perspective view of the fuel cell shown in FIG. 1A;

FIG. 3 is an exploded perspective view showing the schematic configuration of the fuel cell system according to an embodiment;

FIG. 4A is a schematic view of the fuel tank containing a hydrogen absorbing alloy in the fuel cartridge, and FIG. 4B is a graph showing temperature variation occurring in selected parts when hydrogen is discharged from the fuel tank shown in FIG. 4A;

FIG. 5 is a schematic view showing the interior of the fuel cartridge in which fuel tanks are arranged;

FIG. 6A is a schematic view showing how the fuel tank containing hydrogen absorbing alloy in the fuel cartridge is filled with hydrogen, and FIG. 6B is a graph showing temperature variation occurring in selected parts when the fuel tank shown in FIG. 6A is filled with hydrogen;

FIG. 7 is a schematic view showing the interior of the fuel cartridge in which the fuel tanks provided with supply units are arranged;

FIG. 8 show how members forming a manifold are arranged side by side;

FIG. 9 shows the fuel cartridge viewed from above and is an enlarged view of the neighborhood of the supply channel;

FIG. 10A is a top view of the fuel cell system provided with a heat conducting member between the fuel cell and the fuel cartridge, and FIG. 10B is an X-X cross section of the fuel cell system shown in FIG. 10A;

FIG. 11 is a lateral view illustrating the filler unit filing a space between the fuel cell and the fuel tank;

FIG. 12 is a perspective view showing the appearance of the fuel cartridge in which a plurality of fuel tanks according to the second embodiment are arranged;

FIG. 13 is a cross section showing the schematic configuration of the fuel cartridge according to a comparative example;

FIG. 14 is a graph showing temperature variation in the hydrogen absorbing alloy in the fuel tank when hydrogen is discharged;

FIG. 15A is a perspective view showing the appearance of the fuel tank according to the third embodiment;

FIG. 15B is a Y-Y cross section of the fuel tank shown in FIG. 15B;

FIG. 15C is an exploded perspective view showing the essential part of the fuel tank according to the third embodiment;

FIG. 16 is a cross section showing the schematic configuration of the fuel cartridge according to the third embodiment;

FIG. 17 is a graph showing temperature variation in the hydrogen absorbing alloy in the fuel tank according to the third embodiment when hydrogen is discharged;

FIG. 18 is a cross sectional view showing how the hydrogen absorbing alloy in the fuel tank according to the third embodiment contracts;

FIG. 19 is an exploded perspective view showing the essential part of the fuel tank according to the fourth embodiment; and

FIG. 20 is a cross section showing the schematic configuration of the fuel cartridge according to the fourth embodiment.

### DETAILED DESCRIPTION OF THE INVENTION

The invention will now be described by reference to the preferred embodiments. This does not intend to limit the scope of the present invention, but to exemplify the invention.

A description will be given, with reference to the drawings, of the embodiments embodying the present invention. In describing the figures, like numerals represent like constituting elements, and the description thereof is omitted as appropriate. The illustrative features described below shall not be construed as limiting the scope of the present invention.

### First Embodiment

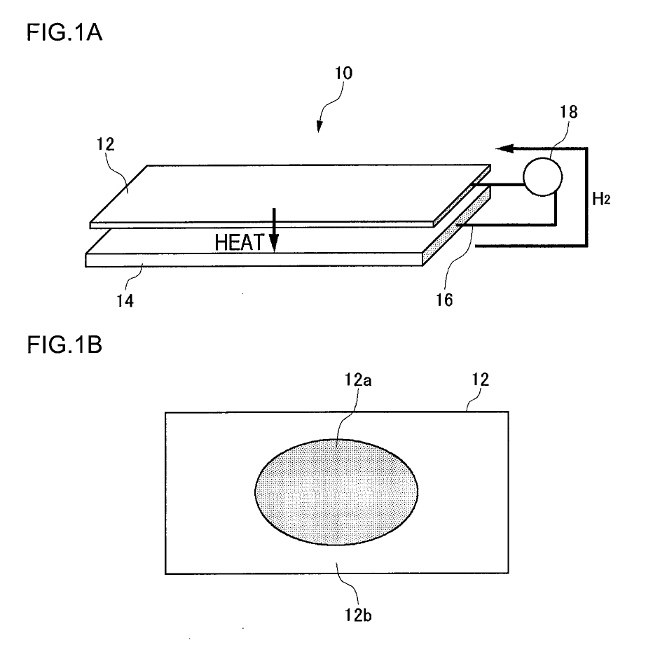

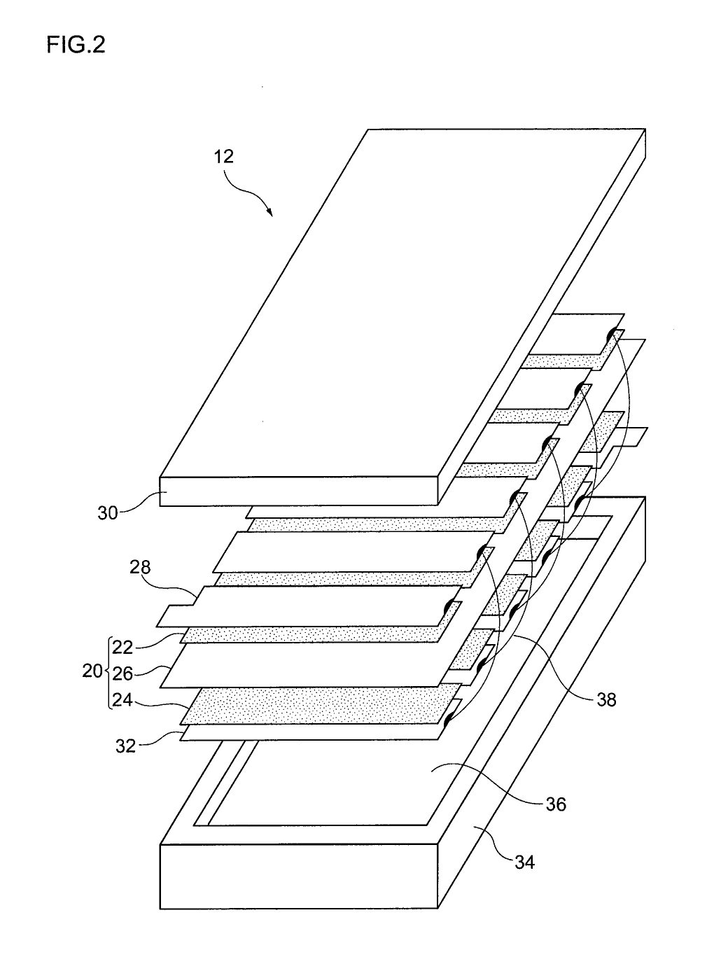

A description will first be given of heat generation occurring when a fuel cell system generates electricity. FIG. 1A is a schematic view of a fuel cell main unit and a fuel tank of a fuel cell system, and FIG. 1B is a top view showing temperature distribution in a fuel cell occurring when electricity is generated. FIG. 2 is an exploded perspective view of the fuel cell shown in FIG. 1A.

The fuel cell system 10 shown in FIG. 1A comprises a fuel cell 12, a fuel cartridge 14 provided opposite to the fuel cell 12, a supply channel 16 configured to supply hydrogen from the fuel cartridge 14 to the fuel cell 12, and a regulator (pressure reducing valve) provided in the middle of the supply channel 16. The fuel cartridge 14 contains a hydrogen absorbing alloy capable of absorbing hydrogen, which is a fuel for the fuel cell 12. The supply channel 16 supplies hydrogen discharged from the hydrogen absorbing alloy to the fuel cell 12.

As shown in FIG. 2, the fuel cell 12 comprises a plurality of cells 20 provided on a plane. Each cell 20 is provided with a membrane electrolyte assembly comprising an anode catalyst layer 22, a cathode catalyst layer 24 and an electrolyte membrane 26 sandwiched by the anode catalyst layer 22 and the cathode catalyst layer 24. Hydrogen is supplied to the anode catalyst layer 22. Air is supplied to the cathode catalyst layer 24. The fuel cell 12 generates electricity by an electrochemical reaction induced between hydrogen and oxygen in the air.

Preferably, the electrolyte membrane 26 exhibits good ionic conductivity in a humid condition and functions as an ion exchange membrane causing protons to travel between the anode catalyst layer 22 and the cathode catalyst layer 24. The electrolyte membrane 26 is formed of a polymer material such as fluorinated polymer or non-fluorinated polymer. For example, perfluorocarbon polymer of sulfonic acid type, polysulfone resin, or perfluorocarbon polymer having a phosphonic acid group or carboxylic acid group may be used. Nafion (trademark) 112 from DuPont is an example of perfluorocarbon polymer of sulfonic acid type. Aromatic sulfonated polyetheretherketone and sulfonated polysulfone are examples of non-fluorinated polymer.

The electrolyte membrane 26 is bonded to one surface of the anode catalyst layer 22 and a current collector 28 is bonded to the other surface of the anode catalyst layer 22. The structure is obtained by forming the anode catalyst layer 22 on the electrolyte membrane 26 by spray coating, screen printing or decalcomania transferring, and then hot pressing the current collector 28 on the layer 22. An anode side housing 30 is provided so as to surround a space including the anode catalyst layer 22.

The anode side housing 30 is provided with a fuel port (not shown) via which a hydrogen gas from, for example, the fuel cartridge 14 provided outside the fuel cell 12 is delivered due to a pressure difference. When the amount of hydrogen in the fuel chamber is decreased, hydrogen is supplied from the fuel cartridge 14 as appropriate.

The electrolyte membrane 26 is bonded to one surface of the cathode catalyst layer 24 and a current collector 32 is bonded to the other surface of the cathode catalyst layer 24. The configuration of the current collector 32 is the same as that of the current collector 28. A cathode side housing 34 is provided so as to surround a space including the cathode catalyst layer 24.

A filter 36 provided with an air intake port (not shown) to take in air is fitted to the major surface of the cathode side housing 34. Air flowing in through the air intake port arrives at the cathode catalyst layer 24. The cells 20 are electrically connected in series. More specifically, the current collector 28 of one cell is connected to the current collector 32 of the adjacent cell via a wiring 38.

Heat is generated in the fuel cell 12 as described above due to a chemical reaction occurring when electricity is generated in the cells 20. In this process, uneven temperature distribution may occur in the fuel cell 12 because heat is dissipated differently depending on the location of the cell 20 or the area in the cell. Of the plurality of cells provided in the fuel cell 12, the one located at the center is affected by adjacent cells and so dissipates heat poorly and the temperature thereof is likely to increase. Consequently, as shown in FIG. 1B, the temperature at a center 12a of the fuel cell 12 may become high.

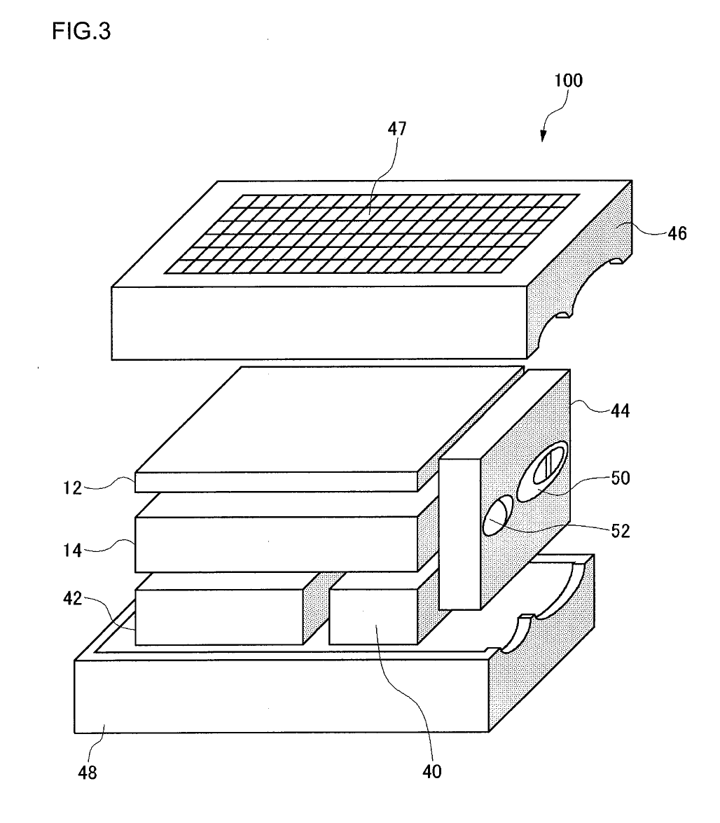

In order to address the disadvantage, the arrangement of the discharging unit of the hydrogen absorbing alloy contained in the fuel cartridge 14 is optimized in order to remedy the unevenness of temperature distribution caused by temperature increase, particularly at the center of the fuel cell 12. FIG. 3 is an exploded perspective view showing the schematic configuration of the fuel cell system according to the embodiment.

A fuel cell system 100 shown in FIG. 3 comprises a fuel cell 12, a fuel cartridge 14 containing hydrogen absorbing alloy capable of storing hydrogen supplied to the fuel cell 12, a controller 40, a secondary cell 42, a pressure reducer 44 connected to the supply channel 16 for supplying hydrogen in the fuel cartridge 14 to the fuel cell 12, and upper and lower housings 46 and 48 separated from each other so as to contain the members. The upper housing 46 is provided with an air intake port 47 for taking air from outside.

The fuel cell 12 generates electricity using hydrogen and oxygen. The fuel cell 12 may be an active cell or a passive cell. For the purpose of miniaturization, a passive fuel cell is favorable because auxiliary units are not necessary. The fuel cartridge 14 contains hydrogen absorbing alloy inside. In this embodiment, a rare earth alloy Mm (Misch metal) Ni_{4.32}Mn_{0.18}Al_{0.1}Fe_{0.11}CO_{0.3} is used as hydrogen absorbing alloy, where Mn denotes misch metal. Alternatively, a rare-earth-Ni alloy, Ti—Mn alloy, Ti—Fe alloy, Ti—Zr alloy, Mg—Ni alloy, or Zr—Mn alloy may be used as hydrogen absorbing alloy.

The controller 40 is responsible for overall control of the fuel cell system 100. The pressure reducer 44 is provided with the regulator 18, a hydrogen cut-off switch 50, and a hydrogen filling port 52. By manipulating the hydrogen cut-off switch 50 as necessary, hydrogen supplied from the fuel cartridge 14 to the fuel cell 12 can be cut off forcibly. The hydrogen filling port 52 is a port for supplying hydrogen as necessary from an external hydrogen source when the amount of hydrogen in the fuel cartridge 14 is reduced. The secondary cell 42 is charged using excess power from the fuel cell 12. Charging and discharging of the secondary cell 42 are controlled by the controller 40.

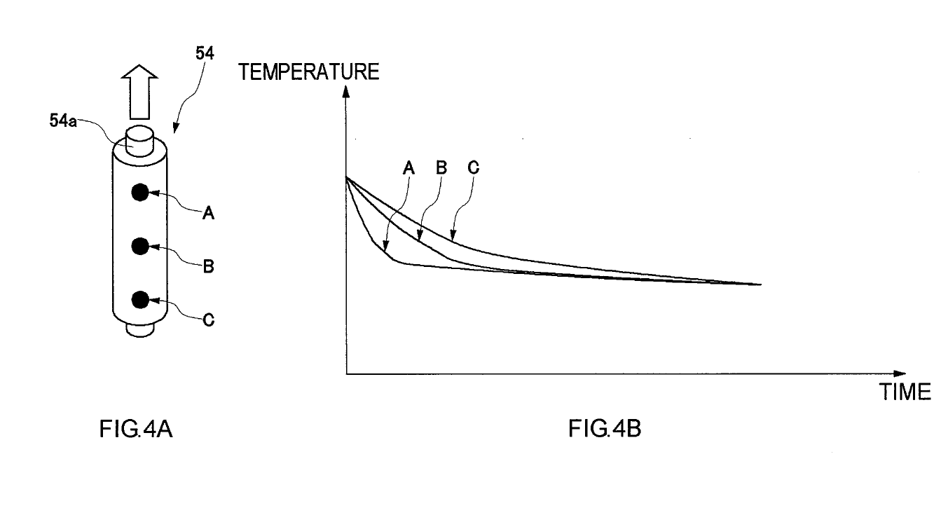

FIG. 4A is a schematic view of the fuel tank containing a hydrogen absorbing alloy in the fuel cartridge, and FIG. 4B is a graph showing temperature variation occurring in selected parts when hydrogen is discharged from the fuel tank shown in FIG. 4A. A fuel tank 54 has a cylindrical housing and is filled with hydrogen absorbing alloy. As mentioned above, the hydrogen absorbing alloy undergoes an endothermic reaction when the alloy discharges hydrogen from inside. For this reason, given that a discharging unit 54a is provided on top of the fuel tank 54 as shown in FIG. 4A, the closer toward the discharging unit 54a, i) the more the hydrogen discharge is facilitated, ii) the larger the amount of heat absorbed, and iii) the more rapidly the temperature drops (see FIG. 4B). In other words, the amount of heat absorbed in area A shown in FIG. 4A near the discharging unit 54a is larger than that in areas B and C away from the discharging unit 54a. This means that the fuel cell can be cooled locally without requiring considerable energy consumption, by locating the high-temperature part of the fuel cell in the neighborhood of the discharging unit 54a.

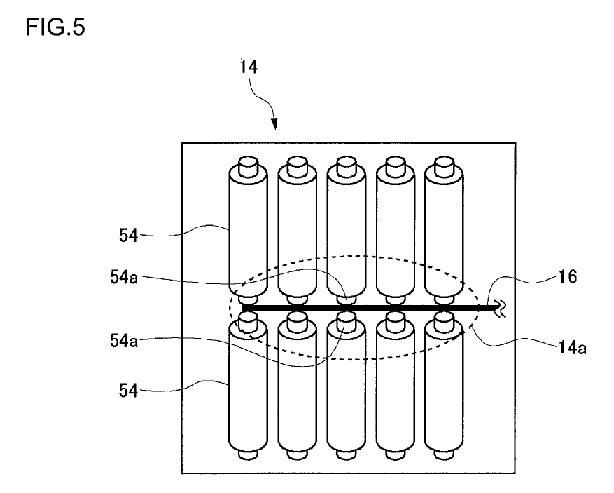

FIG. 5 is a schematic view showing the interior of the fuel cartridge in which fuel tanks are arranged. As shown in FIG. 5, a plurality of fuel tanks 54 are arranged on a plane in a plurality of rows (2 rows in FIG. 5) sandwiching the supply channel 16 at the center. The discharging unit 54a is connected to the supply channel 16 and is located at the center of the fuel cartridge 14. The fuel tanks 54 according to the embodiment are arranged such that the ends thereof provided with the discharging units 54a are nearer a center 14a of the fuel cartridge 14.

As shown in FIG. 3, according to the embodiment, the area occupied by the fuel cell 12 and the area occupied by the fuel cartridge 14 are substantially identical as viewed from above. Therefore, the center 14a of the fuel cartridge 14 where the discharging units 54a are located is opposite to the center 12a of the fuel cell 12. If the fuel cell and the fuel cartridge are not aligned or differ in size, the location of the discharging units 54a of the fuel cartridge 14 need not be the center 14a of the fuel cartridge 14 so long as the discharging units 54a are located opposite to the center 12a of the fuel cell 12.

Thus, since the discharging unit 54a for discharging hydrogen is provided opposite to the center 12a of the fuel cell 12 in the fuel cell system 100 according to the embodiment, heat generated while electricity is being generated is canceled by the endothermic reaction in the neighborhood of the discharging unit 54a. As a result, temperature increase at the center of the fuel cell is mitigated and unevenness of the temperature distribution is moderated. The difference in outputs from the cells in the fuel cell system 100 is reduced as a result of uniform temperature distribution in the fuel cell 12 so that highly stable and efficient operation is possible.

Also, as shown in FIG. 5, by arranging the plurality of fuel tanks 54, allowing for the position of the discharging unit 54a, the volume of hydrogen absorbing alloy per fuel tank 54 is reduced as compared to the fuel cartridge in which all hydrogen absorbing alloy pieces are contained in a single housing. This increases the rigidity of the housing used in the fuel tank 54 and the flexibility in the shape of the housing, allowing cost reduction. By using standardized fuel tanks 54, the fuel cartridge 14 adapted for the performance of the fuel cell 12 and the type of the cell phone connected to the cell can be easily manufactured simply by changing the number of fuel tanks 54.

Additionally, since each of the plurality of fuel tanks 54 is arranged so that the discharging unit 54a thereof is located at the center 14a of the fuel cartridge 14, the center 12a of the fuel cell 12 in which the temperature is likely to rise can be efficiently cooled. By arranging the fuel tanks 54 on a plane, the thickness of the fuel cartridge 14 can be reduced. In the case that the fuel cartridge 14 has a rectangular shape as a whole, the term “center” may not only be understood to mean an area including the center from all sides but also an area including the center of the two opposite sides (the supply channel 16 shown in FIG. 5.

The hydrogen absorbing alloy not only undergoes an endothermic reaction when discharging hydrogen but also undergoes an exoergic reaction when absorbing hydrogen. By providing the discharging unit opposite to the high-temperature part of the fuel cell, the temperature in the high-temperature part can be reduced. However, the temperature may not be sufficiently uniform over the entirety of the fuel cell merely by exploiting an endothermic reaction, depending on the case. By heating the relatively low-temperature peripheral part of the fuel cell while cooling the high-temperature center of the fuel cell, uniform temperature distribution over the entirety of the fuel cell is achieved.

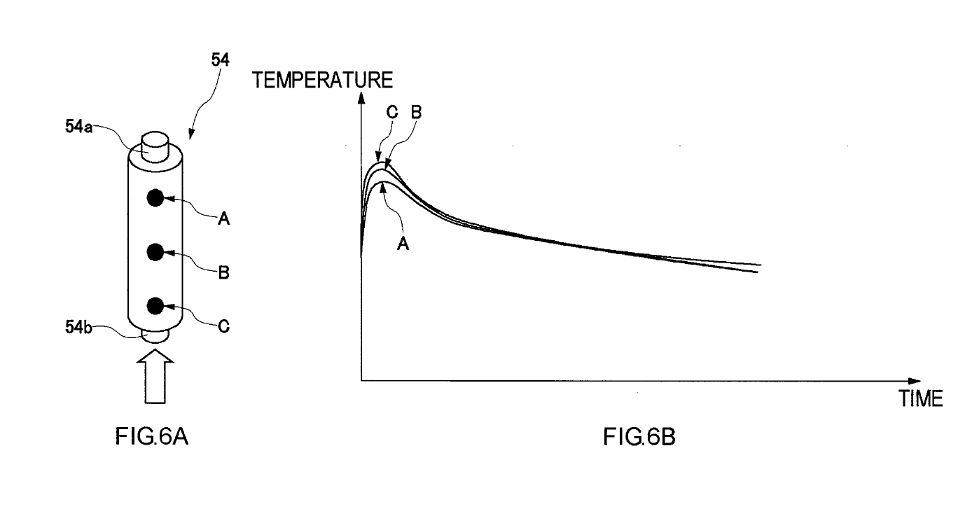

FIG. 6A is a schematic view showing how the fuel tank containing hydrogen absorbing alloy in the fuel cartridge is filled with hydrogen, and FIG. 6B is a graph showing temperature variation occurring in selected parts when the fuel tank shown in FIG. 6A is filled with hydrogen.

The hydrogen absorbing alloy undergoes an exoergic reaction when absorbing hydrogen. Therefore, given that a supply unit 54b is provided at the bottom of the fuel tank 54 as shown in FIG. 6A, the closer toward the supply unit 54b, i) the more the hydrogen filling is facilitated, ii) the larger the amount of heat generated, and iii) the more rapidly the temperature rises initially (see FIG. 6B). In other words, the amount of heat generated in area C shown in FIG. 6A near the supply unit 54b is larger than that in areas B and A away from the supply unit 54b. This means that the fuel cell can be heated locally without requiring considerable energy consumption, by locating the low-temperature part of the fuel cell in the neighborhood of the supply unit 54b.

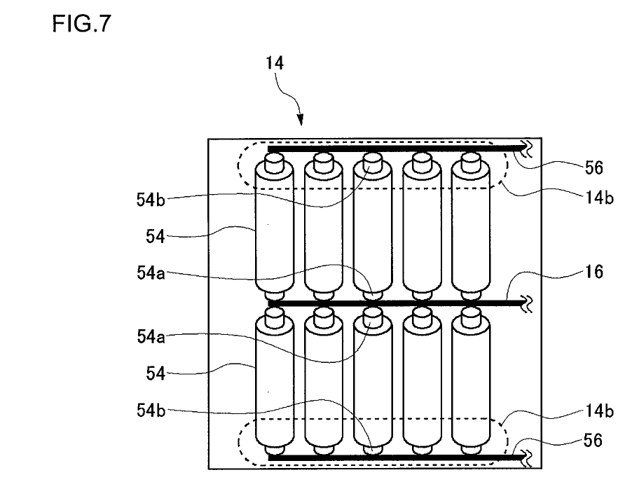

FIG. 7 is a schematic view showing the interior of the fuel cartridge in which fuel tanks each provided with the supply unit 54b are arranged. As shown in FIG. 7, a plurality of fuel tanks 54 are arranged on a plane in a plurality of rows sandwiching the supply channel 16 at the center. As in FIG. 5, the discharging unit 54a is connected to the supply channel 16 and is located at the center of the fuel cartridge 14. The fuel tanks 54 shown in FIG. 7 are arranged such that the ends opposite to the ends thereof provided with the discharging units 54a are provided with the supply units 54b. The supply unit 54b is connected to the supply channel 56 and communicates with the hydrogen filling port 52 provided in the pressure reducer 44 via the supply channel 56.

Thus, since an end area 14b of the fuel tank 54 shown in FIG. 7 opposite to the end provided with the discharging unit 54a is provided with the supply unit 54b for supplying hydrogen, a peripheral part 12b (see FIG. 1B), which is at a lower temperature than the center 12a of the fuel cell 12, can be heated. Therefore, unevenness of temperature distribution in the fuel cell 12 is further mitigated in comparison with the case where the center 12a of the fuel cell 12 is merely cooled.

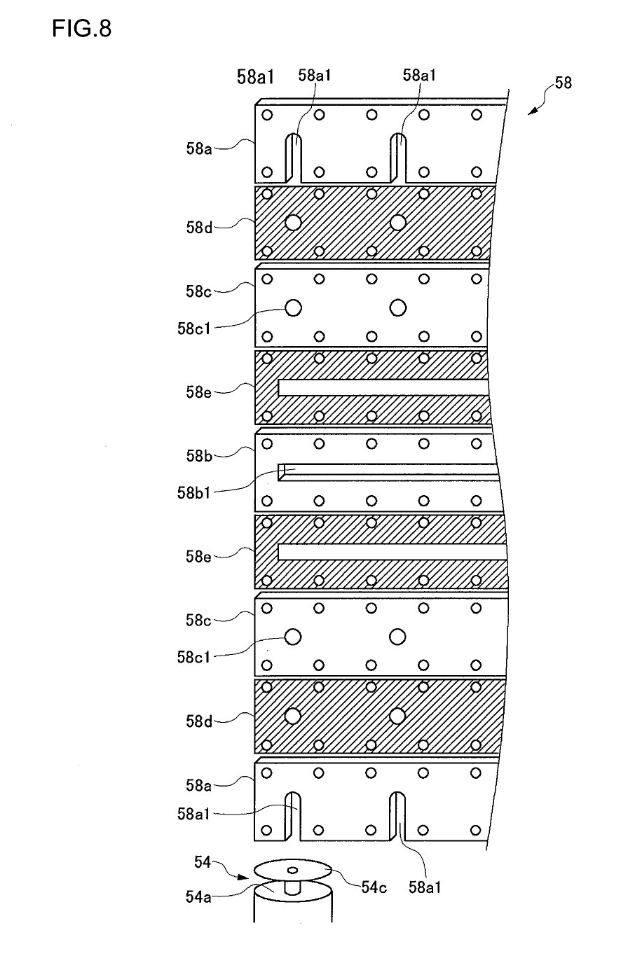

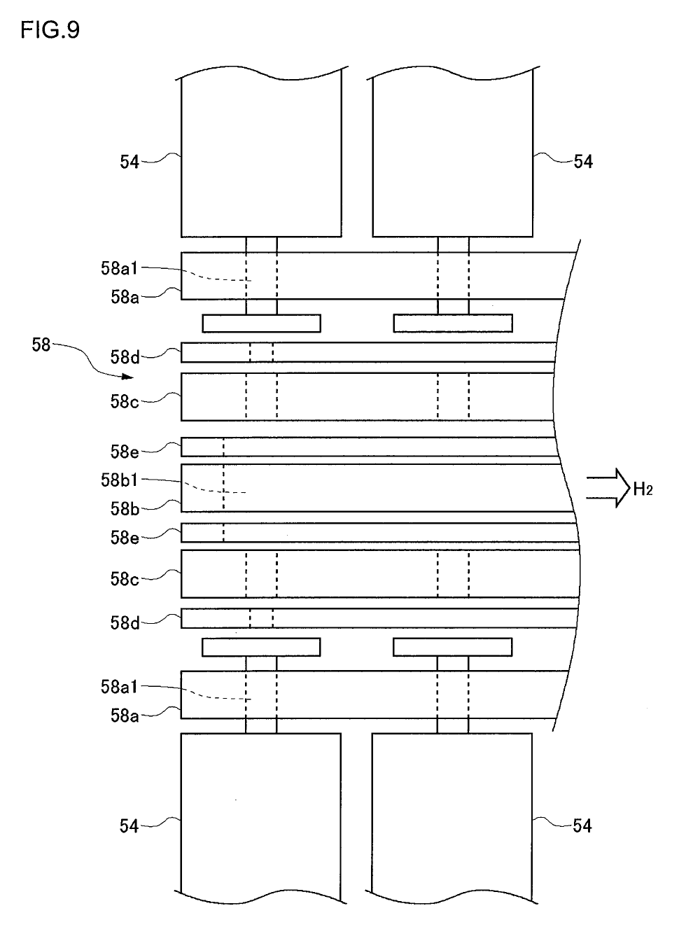

A description will now be given of the structure of a manifold forming the supply channel 16. FIG. 8 show how members forming the manifold are arranged side by side. FIG. 9 shows the fuel cartridge viewed from above and is an enlarged view of the neighborhood of the supply channel.

As shown in FIGS. 8 and 9, a manifold 58 forming the supply channel 16 connected to the fuel tanks 54 is provided with a metal plate 58a for securing the discharging units 54a of the plurality of fuel tanks 54. The metal plate 58a is provided with a plurality of slits 58a1 for securing the small-diameter part between the discharging unit 54a and a disk part 54c formed at the end thereof. The manifold 58 is further provided with a metal plate 58b formed with a channel 58b1 and two metal plates 58c formed with a through hole 58c1 for communication between the discharging unit 54a and the channel 58b1. Packings 58d and 58e each formed with a channel and a hole are sandwiched between the metal plates.

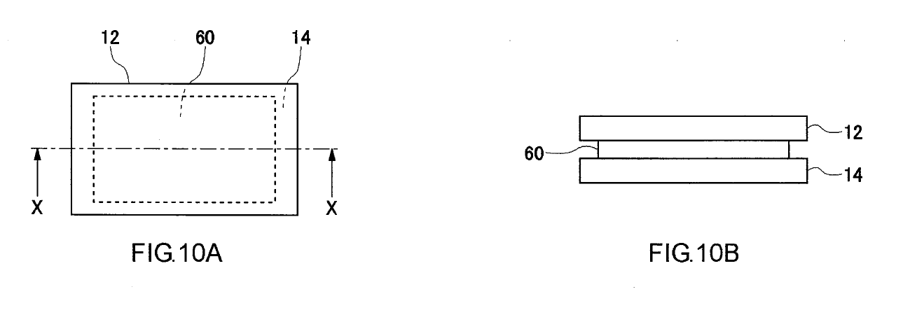

A detailed description will now be given of means to promote heat transfer between the fuel cell 12 and the fuel cartridge 14. Heat can be transferred by providing the fuel cell 12 and the fuel cartridge 14 opposite to each other. However, efficient heat transfer may not be achieved depending on the shape of the fuel cell 12 and the fuel cartridge 14. FIG. 10A is a top view of the fuel cell system provided with a heat conducting member between the fuel cell and the fuel cartridge, and FIG. 10B is an X-X cross section of the fuel cell system shown in FIG. 10A.

A heat conducting member 60 is sandwiched by the fuel cell 12 and the fuel cartridge 14 and promotes heat transfer between the fuel cell 12 and the fuel cartridge 14. More specifically, a heat conducting member formed by dispersing a metal filler, which has a high thermal conductivity, in silicone may be suitably used. This facilitates transfer of heat due to the temperature difference between the fuel cell 12 and the fuel cartridge 14 and promotes uniform temperature distribution in the fuel cell 12.

The heat conducting member 60 may be configured such that the heat conductivity at the center within the plane is larger than the heat conductivity at the edges. This facilitates transfer of heat at the center 12a of the fuel cell 12 toward the edges or toward the fuel cartridge 14 via the center of the heat conducting member 60, thereby promoting uniform temperature distribution in the fuel cell. The heat conductivity of the heat conducting member 60 may be made to differ within the plane by varying the amount of metal filler from place to place.

The sheet-shaped heat conducting member 60 as described above may not provide its advantage sufficiently unless the fuel tanks 54 of the fuel cartridge 14 are contained in a box-shaped housing. Therefore, a description will now be given of means capable of transferring heat efficiently even when the fuel tanks 54 are directly opposite to the fuel cell 12.

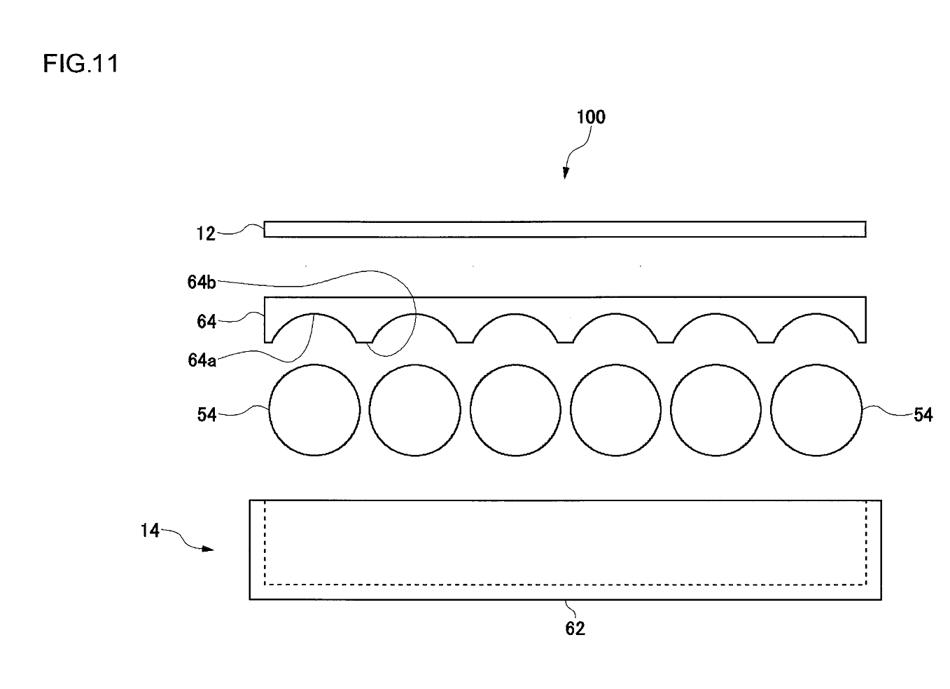

FIG. 11 is a lateral view illustrating the filler unit filing a space between the fuel cell and the fuel tank. As shown in FIG. 11, the fuel the plurality of fuel tanks 54 in the fuel cartridge 14 are arranged side by side in a housing 62 with an open top. Therefore, a convex part is produced on the top of the arrangement where the fuel tank 54 is located and a concave part is produced between the fuel tanks 54. A filler unit 64 fills a space between the fuel cell 12 and the fuel tanks 54. The filler unit 64 according to this embodiment is formed with a recess 64a in conformity with the shape of the fuel tanks 54 and the dimension of the unit 64 is configured such that the unit 64 is in intimate contact with the cylindrical parts of the fuel tanks 54 when the fuel cell 12 is attached to the fuel cartridge 14.

The entire surface of the filler unit 64 need not be in contact with the fuel tanks 54. The unit 64 may be formed with a rib 64b that enters the recess between the fuel tanks 54 to some extent. This makes heat transfer between the fuel cell 12 and the fuel tanks 54 due to the temperature difference easier than in the case where a large space exists between the fuel cell 12 and the fuel tanks 54, thereby promoting uniform temperature distribution in the fuel cell.

### Second Embodiment

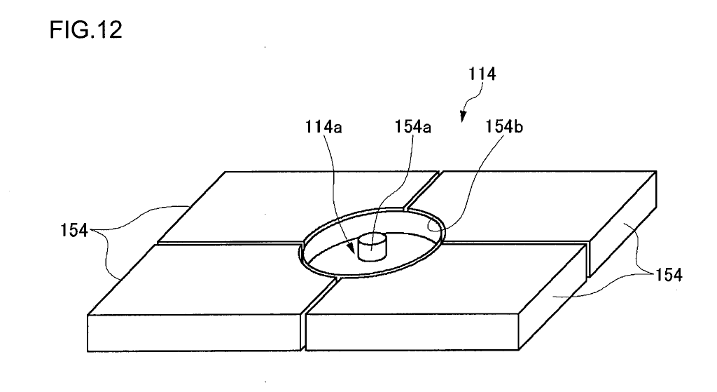

FIG. 12 is a perspective view showing the appearance of the fuel cartridge in which a plurality of fuel tanks according to the second embodiment are arranged. The configuration of the fuel cell system according to this embodiment is the same as that of the first embodiment except for the fuel cartridge. Therefore, the description of the components other than the fuel cartridge is omitted as appropriate and it will be assumed that the system has the same configuration as that of the first embodiment unless specifically referred to.

As shown in FIG. 12, a fuel cartridge 114 according to the second embodiment is provided with a plurality of rectangular fuel tanks 154 in an arranged, and a discharging unit 154a connected to the fuel tanks 154. Each fuel tank 154 has a shape in which one of its corners 154b is cut out. The discharging unit 154a is provided in a space formed by cutting out the corners 154b of the fuel tanks 154. Thus, the fuel cartridge 114 is configured such that the plurality of fuel tanks 154 are arranged and the discharging unit 154a is provided at the center.

According to the embodiment, as in the case of the first embodiment, the area occupied by the fuel cell 12 (see FIG. 3) and the area occupied by the fuel cartridge 114 are substantially identical as viewed from above. Therefore, the center 114a of the fuel cartridge 114 where the discharging unit 154a is located is opposite to the center 12a (see FIG. 1B) of the fuel cell 12. If the fuel cell and the fuel cartridge are not aligned or differ in size, the location of the discharging units 154a of the fuel cartridge 114 need not be the center 114a of the fuel cartridge 114 so long as the discharging units 154a are located opposite to the center 12a of the fuel cell 12.

Thus, since the discharging unit 154a for discharging hydrogen is provided opposite to the center 12a of the fuel cell 12 in the fuel cell system according to this embodiment, heat generated while electricity is being generated is canceled by the endothermic reaction in the neighborhood of the discharging unit 154a. As a result, temperature increase at the center 12a of the fuel cell 12 is mitigated and unevenness of the temperature distribution is moderated. The difference in outputs from the cells in the fuel cell system is reduced as a result of uniform temperature distribution in the fuel cell 12 so that highly stable and efficient operation is possible.

Also, as shown in FIG. 12, by arranging the plurality of fuel tanks 154, allowing for the position of the discharging unit 154a, the volume of hydrogen absorbing alloy per fuel tank 154 is reduced as compared to the fuel cartridge in which all hydrogen absorbing alloy pieces are contained in a single housing. This increases the rigidity of the housing used in the fuel tank 154 and the flexibility in the shape of the housing, allowing cost reduction. By using standardized fuel tanks 154, the fuel cartridge 114 adapted for the performance of the fuel cell 12 and the type of the cell phone connected to the cell can be easily manufactured simply by changing the number of fuel tanks 54.

Additionally, since each of the plurality of fuel tanks 154 is arranged so that the discharging unit 154a thereof is located at the center 114a of the fuel cartridge 114, the center 12a of the fuel cell 12 in which the temperature is likely to rise can be efficiently cooled. By arranging the fuel tanks 154 on a plane, the thickness of the fuel cartridge 114 can be reduced.

(Configuration of Fuel Tank)

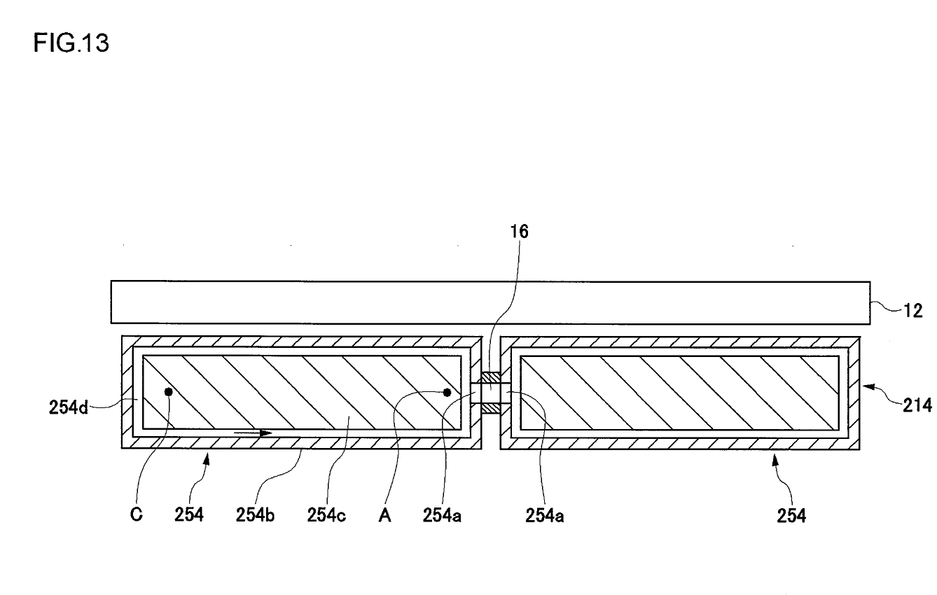

The volume of hydrogen absorbing alloy changes as a result of absorbing or discharging hydrogen. For this reason, it is favorable that a gap be provided between the hydrogen absorbing alloy and the interior wall of the housing that contains the hydrogen absorbing alloy. FIG. 13 is a cross section showing the schematic configuration of the fuel cartridge according to a comparative example.

In a fuel cartridge 214 according to the comparative example, discharging units 254a of a pair of fuel tanks 254 are provided opposite to each other. The discharging units 254a are connected to the supply channel 16 for supplying hydrogen to the fuel cell 12. The fuel tank 254 is provided with a cylindrical housing 254b and hydrogen absorbing alloy 254c contained in the housing 254b. The size and shape of the housing 254b and the hydrogen absorbing alloy 254c are configured such that a gap 254d is created between the interior wall of the housing 254b and the hydrogen absorbing alloy 254c. Therefore, hydrogen can move freely inside the housing 254b through the gap 254d.

The hydrogen absorbing alloy 254c undergoes an endothermic reaction when the alloy discharges hydrogen. For this reason, the temperature in the neighborhood of area A drops as hydrogen is discharged from area A of the hydrogen absorbing alloy 254c in the neighborhood of the discharging unit 254a toward the discharging unit 254a. Meanwhile, hydrogen can also be discharged from area C of the hydrogen absorbing alloy 254c away from the discharging unit 254a toward the gap 254d. Therefore, the temperature of area C also drops.

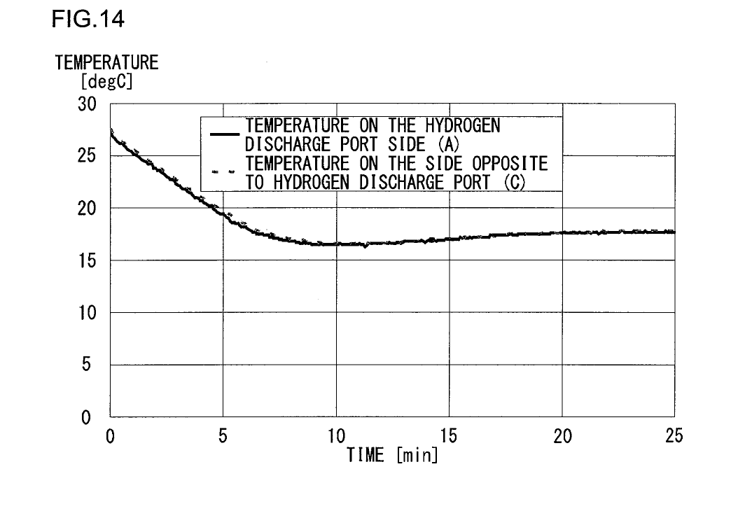

FIG. 14 is a graph showing temperature variation in the hydrogen absorbing alloy in the fuel tank 254 when hydrogen is discharged. When the gap 254d is formed between the housing 254b and the hydrogen absorbing alloy 254c, hydrogen is discharged from anywhere in the peripheral part of the hydrogen absorbing alloy 254c. Therefore, the temperature drops in a uniform manner, and it is difficult to cause the temperature in area A in the neighborhood of the discharging unit 254a (i.e., the center of the fuel cartridge 214) to drop more significantly than in area C away from the discharging unit 254a.

### Third Embodiment

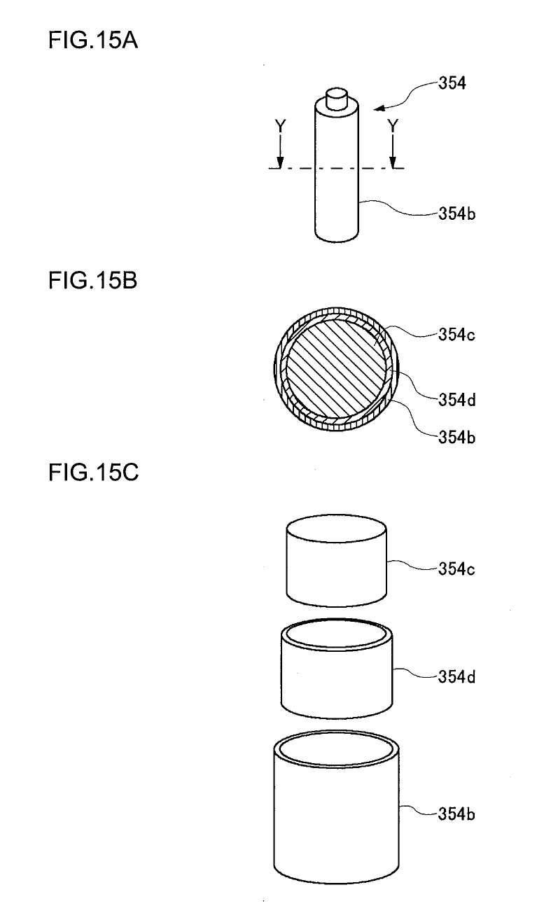

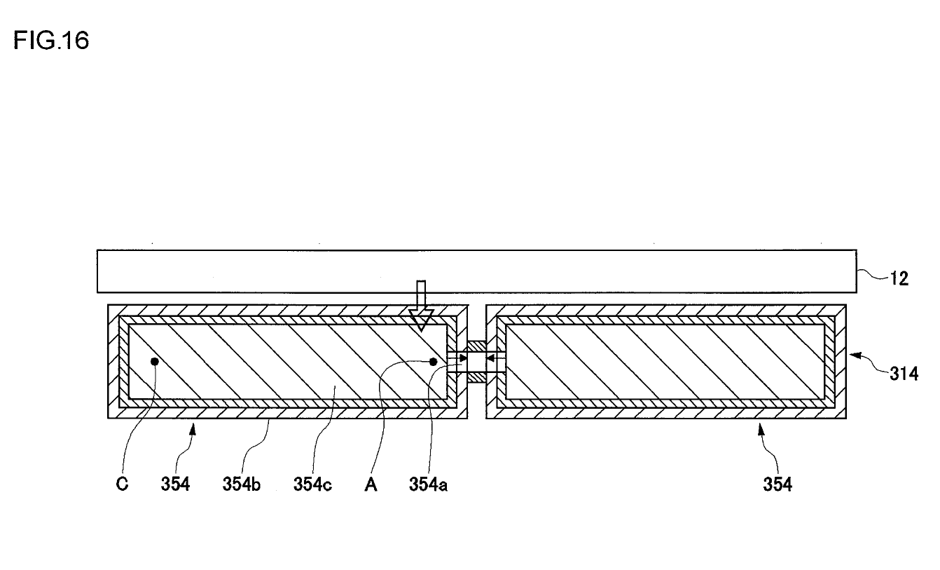

A filler member filling a gap between the interior surface of the housing and the hydrogen absorbing alloy is provided in the fuel tank according to the third embodiment. FIG. 15A is a perspective view showing the appearance of the fuel tank according to the third embodiment. FIG. 15B is a Y-Y cross section of the fuel tank shown in FIG. 15B. FIG. 15C is an exploded perspective view showing the essential part of the fuel tank according to the third embodiment. FIG. 16 is a cross section showing the schematic configuration of the fuel cartridge according to the third embodiment.

As shown in FIGS. 15A-16, a fuel tank 354 is provided with a housing 354b, a molded hydrogen absorbing alloy 354c contained in the housing 354b, and a filler member 354d filling a gap between the interior surface of the housing 354b and the hydrogen absorbing alloy 354c. A plurality of molded hydrogen absorbing alloy pieces 354c are arranged in the fuel tank 354. The housing 354b comprises a material having a high thermal conductivity (e.g., metal). The filler member 354d comprises an elastic material deformed in accordance with contraction and expansion of the hydrogen absorbing alloy 354c. Preferably, rubber or felt may be used as the elastic material. It is also preferable that the filler material 354d have the property and shape not readily permeable to hydrogen. The filler material 354d may have a shape that only fills a part of the gap instead of the entirety of the gap.

Since the fuel tank 354 is configured such that the filler member 354d is provided in a gap between the housing 354b and the hydrogen absorbing alloy 354c, movement of hydrogen outside the hydrogen absorbing alloy is restricted. In other words, hydrogen is prevented from being discharged from the hydrogen absorbing alloy 354c other than at the area designed as such. When the discharge is started, hydrogen is discharged from area A of the hydrogen absorbing alloy 354c near the discharging unit 354c. When hydrogen is discharged near the discharging unit 354a, the temperature drops significantly due to the difference between the hydrogen pressure in the hydrogen absorbing alloy 354c and that of the discharging unit 354a is large. Thereafter, the area where hydrogen is discharged will be shifted away from the discharging unit 354a and approaches area C. An endothermic reaction will still occur at this stage as a result of discharging hydrogen. However, the amount of hydrogen discharged will be reduced due to the drop in hydrogen concentration with the result that the associated temperature drop is decreased.

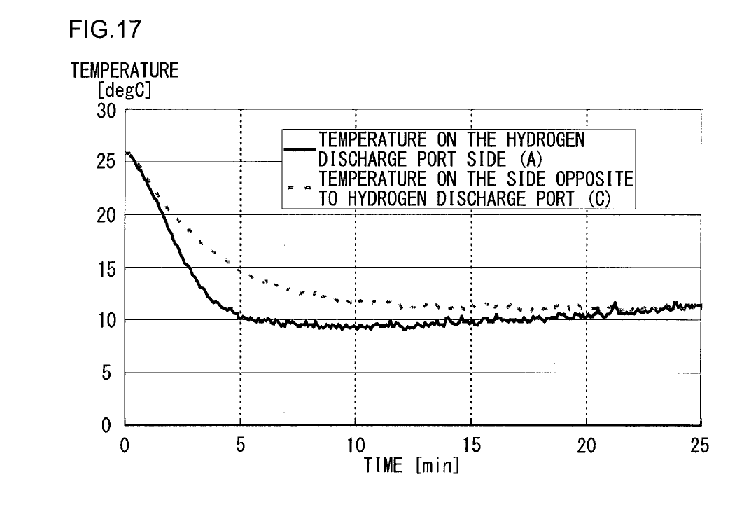

FIG. 17 is a graph showing temperature variation in the hydrogen absorbing alloy in the fuel tank 354 according to the third embodiment when hydrogen is discharged. When the filler member 354d is provided in a gap between the housing 354b and the hydrogen absorbing alloy 354c, hydrogen is rapidly discharged from area A of the hydrogen absorbing alloy 354c in the neighborhood of the discharging unit 354a. Therefore, the temperature of area A in the neighborhood of the discharging unit 354a (i.e., the center of the fuel cartridge 314) rapidly drops. Meanwhile, the temperature drop in area C away from the discharging unit 354a is more gradual than in area A. As a result, it is ensured that the temperature in the neighborhood of the discharging unit (area A) drops more significantly than in area C away from the discharging unit 354a as a result of discharging hydrogen from the hydrogen absorbing alloy 354c.

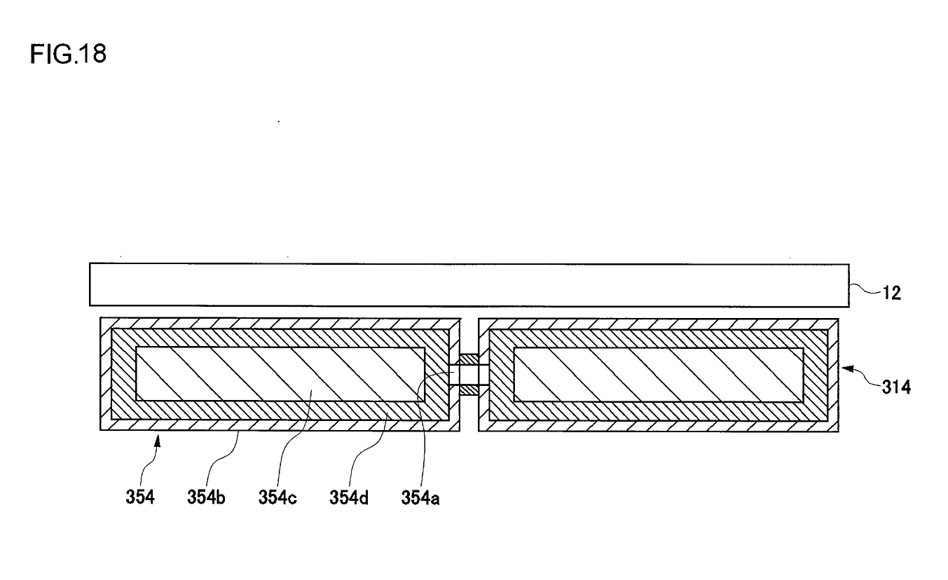

Since the filler member 354d according to this embodiment is an elastic member, the member 354d can conform to a change in the volume of the hydrogen absorbing alloy 354c. FIG. 18 is a cross sectional view showing how the hydrogen absorbing alloy in the fuel tank according to the third embodiment contracts.

As shown in FIG. 18, since an elastic member is used as the filler member 354d in the fuel tank 354 according to this embodiment, no gaps are created even if the interval between the hydrogen absorbing alloy 354c and the housing 354b changes as a result of discharge of hydrogen and associated contraction of the alloy. For this reason, hydrogen absorbed in the hydrogen absorbing alloy 354c continues to be discharged toward the discharging unit 354a so that discharge of hydrogen toward the gap (see FIG. 13) is restricted. This restricts the temperature drop in the area of the hydrogen absorbing alloy 354c away from the discharging unit 354a and promotes the temperature drop in the neighborhood of the discharging unit 354a.

The filler member 354d may function as a heat conducting unit adapted to conduct heat generated by the fuel cell 12 to the hydrogen absorbing alloy 354c. For example, metal felt or silicone rubber dispersed with metal particles may be used as a material for the heat conducting member. By using such a material, absorption of heat generated by the fuel cell 12 and discharge of hydrogen from the hydrogen absorbing alloy 354c are facilitated. In other words, the high-temperature part of the fuel cell can be cooled by an endothermic reaction occurring when the hydrogen absorbing alloy 354c discharges hydrogen.

### Fourth Embodiment

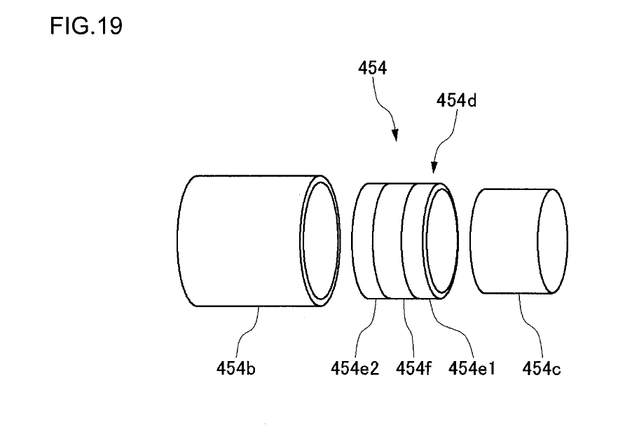

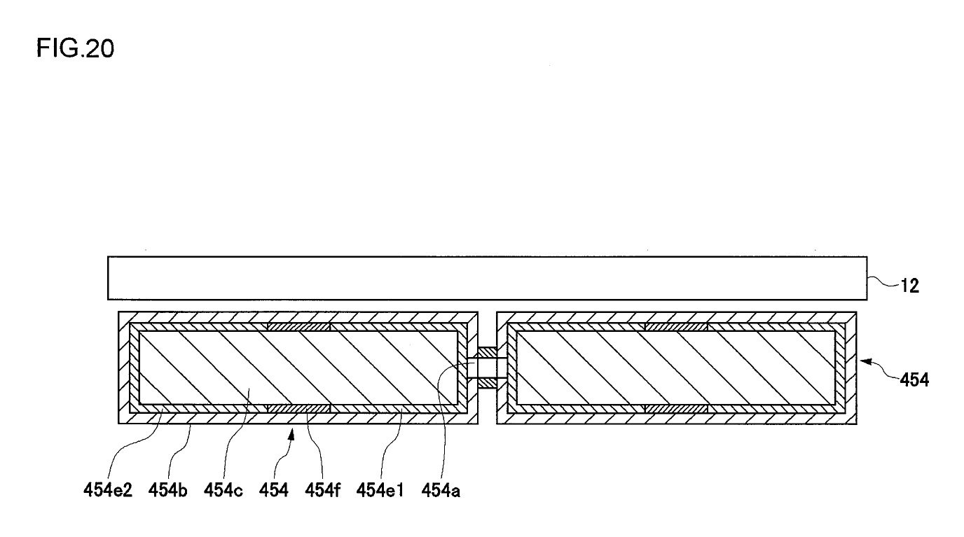

A major characteristic of the fuel tank according to the fourth embodiment is that a heat insulating unit is provided in a part of the filler member according to the third embodiment. FIG. 19 is an exploded perspective view showing the essential part of the fuel tank according to the fourth embodiment. FIG. 20 is a cross section showing the schematic configuration of the fuel cartridge according to the fourth embodiment.

As shown in FIG. 19, a fuel tank 454 is provided with a housing 454b, a molded hydrogen absorbing alloy 454c contained in the housing 454b, and a filler member 454d filling a gap between the interior surface of the housing 454b and the hydrogen absorbing alloy 454c. As in the case of the third embodiment, the filler member 454d comprises an elastic material deformed in accordance with contraction and expansion of the hydrogen absorbing alloy 454c.

The filler member 454d comprises a first heat conducting unit 454e1 provided in the neighborhood of the discharging unit 454a, a second heat conducting unit 454e2 provided in the neighborhood of the area opposite to the discharging unit 454a, and a heat insulating unit 454f provided at a location sandwiched by the first heat conducting unit 454e1 and the second heat conducting unit 454e2. This blocks the flow of heat from the area away from the discharging unit 454a toward the discharging unit 454a via the heat conducting units 454e1 an 454e2. This allows the temperature difference between the area away from the discharging unit 454a and the neighborhood of the discharging unit 454a to be maintained easily and lowers the temperature in the neighborhood of the discharging unit. For example, glass fiber felt, resin fiber felt, or silicone rubber may be used as a material for the heat insulating unit.

The embodiments of the present invention are not limited to those described above by way of example and appropriate combinations or replacements of the configurations of the embodiments are also encompassed by the present invention. Various modifications (e.g., design modifications) may be exercised in the fuel cells or the fuel cell systems according to the embodiments based on the knowledge of a skilled person, and the embodiments thus modified may also be encompassed by the scope of the present invention.

It is indicated above that the hydrogen absorbing alloy pieces contained in a plurality of fuel tanks are of the same type according to the embodiments. Alternatively, a plurality of types of fuel tanks containing hydrogen absorbing allows capable of absorbing different amounts of heat may be used. For example, a fuel tank containing hydrogen absorbing alloy capable of absorbing a large amount of heat may be located opposite to the center (high-temperature part) of the fuel cell, and fuel tanks containing hydrogen absorbing alloy capable of absorbing a small amount of heat may be located toward the peripheral part. This causes the temperature distribution in the fuel cell to become even more uniform. In this case, a pressure reducing valve may be provided for each fuel tank or for each type of hydrogen absorbing alloy so as to average the discharge pressure.

What is claimed is:

1. A fuel cell system comprising:
a fuel cell including an electrolyte membrane, a cathode provided on one surface of the electrolyte membrane, and an anode provided on the other surface of the electrolyte membrane;
a fuel cartridge provided opposite to the fuel cell and adapted to contain hydrogen absorbing alloy; and
a supply channel adapted to supply hydrogen discharged from the hydrogen absorbing alloy to the fuel cell,
wherein the fuel cartridge is provided with a discharging unit adapted to discharge hydrogen from the hydrogen absorbing alloy to the supply channel, and
the discharging unit is provided opposite to the center of the fuel cell.

2. The fuel cell system according to claim 1,
wherein the fuel cartridge includes a plurality of fuel tanks configured to contain hydrogen absorbing alloy and provided with the discharging unit,
wherein each of the plurality of fuel tanks is arranged so that the discharging unit is located at the center of the fuel cartridge.

3. The fuel cell system according to claim 2,
wherein the fuel cartridge is configured such that a plurality of fuel tanks containing hydrogen absorbing alloy are arrange on a plane, and
the fuel tanks are arranged such that one of the ends thereof provided with the discharging unit is located near the center of the fuel cartridge.

4. The fuel cell system according to claim 3,
wherein the fuel tank is provided with a supply unit configured to supply hydrogen to the end opposite to the end provided with the discharging unit.

5. The fuel cell system according to claim 2, further comprising:
a filler unit that fills a space between the fuel cell and the fuel tanks,
wherein the filling unit is formed to conform to the shape of the fuel tanks.

6. The fuel cell system according to claim 3, further comprising:
a filler unit that fills a space between the fuel cell and the fuel tanks,
wherein the filling unit is formed to conform to the shape of the fuel tanks.

7. The fuel cell system according to claim 4, further comprising:
a filler unit that fills a space between the fuel cell and the fuel tanks,
wherein the filling unit is formed to conform to the shape of the fuel tanks.

8. The fuel cell system according to claim 2,
wherein the fuel tank comprises:
a housing;
a molded hydrogen absorbing alloy contained in the housing; and
a filler member filling a gap between the interior surface of the housing and the hydrogen absorbing alloy,
wherein the filler member comprises an elastic material deformed in accordance with contraction and expansion of the hydrogen absorbing alloy.

9. The fuel cell system according to claim 3,
wherein the fuel tank comprises:
a housing;
a molded hydrogen absorbing alloy contained in the housing; and
a filler member filling a gap between the interior surface of the housing and the hydrogen absorbing alloy,
wherein the filler member comprises an elastic material deformed in accordance with contraction and expansion of the hydrogen absorbing alloy.

10. The fuel cell system according to claim 4,
wherein the fuel tank comprises:
a housing;
a molded hydrogen absorbing alloy contained in the housing; and
a filler member filling a gap between the interior surface of the housing and the hydrogen absorbing alloy,
wherein the filler member comprises an elastic material deformed in accordance with contraction and expansion of the hydrogen absorbing alloy.

11. The fuel cell system according to claim 5,
wherein the fuel tank comprises:
a housing;
a molded hydrogen absorbing alloy contained in the housing; and
a filler member filling a gap between the interior surface of the housing and the hydrogen absorbing alloy,
wherein the filler member comprises an elastic material deformed in accordance with contraction and expansion of the hydrogen absorbing alloy.

12. The fuel cell system according to claim 8,
wherein the filler member is provided with a heat conducting unit adapted to conduct heat generated in the fuel cell to the hydrogen absorbing alloy.

13. The fuel cell system according to claim 12,
wherein the filler member is provided with a heat insulating unit that blocks the flow of heat from the area away from the discharging unit toward the discharging unit via the heat conducting unit.

14. The fuel cell system according to claim 13,
wherein the heat conducting unit is provided with a first heat conducting unit provided in the neighborhood of the discharging unit and a second heat conducting unit provided in the neighborhood of the area opposite to the discharging unit, and
the heat insulating unit is provided at a location sandwiched by the first heat conducting unit and the second heat conducting unit.

15. The fuel cell system according to claim 1, further comprising:
a heat conducting member sandwiched by the fuel cell and the fuel cartridge and promoting heat conduction between the fuel cell and the fuel cartridge.

16. The fuel cell system according to claim 15,
wherein the heat conducting member is configured such that the heat conductivity at the center within the plane is larger than the heat conductivity at the edges.
